(19) United States
(12) Patent Application Publication
(10) Pub. No.: US 2016/0301978 A1
(43) Pub. Date: Oct. 13, 2016

(54) TV, METHOD AND DEVICE FOR PROCESSING PLAY HISTORIES IN THE TV

(71) Applicant: LE SHI ZHI XIN ELECTRONIC TECHNOLOGY (TIANJIN) LIMITED, Beijing (CN)

(72) Inventors: Peng HUANG, ChaoYang District, Beijing (CN); Jiazi TIAN, ChaoYang District, Beijing (CN); Yonghui TONG, ChaoYang District, Beijing (CN)

(21) Appl. No.: 15/032,135

(22) PCT Filed: Nov. 27, 2014
(86) PCT No.: PCT/CN2014/092333

§ 371 Date: Apr. 26, 2016

(30) Foreign Application Priority Data
Dec. 2, 2013 (CN) 201310639877.0
Dec. 6, 2013 (CN) 201310649218.5

(51) Int. Cl. H04N 21/472; H04N 21/482; H04N 21/431; H04N 21/432

(52) U.S. Cl. CPC H04N 21/472; H04N 21/4325; H04N 21/482; H04N 21/4312

(57) ABSTRACT

The present disclosure provides a TV, a method and a device for processing play histories in the TV. The TV has a screen on which a timeline is displayed vertically, N points in time are displayed at one side of the timeline, each of the N points in time corresponds to a play history set which includes one or more play histories, among which a play history set corresponding to an n-th point in time is displayed between the n-th point in time and an (n+1)-th point in time at the other side of the timeline, wherein 0<n<N−1. The method includes: receiving an operation command for the play histories sent from a user; detecting a position where an operation focus currently is; and processing the play histories according to the operation command and the position where the operation focus currently is.

### CROSS-REFERENCE TO RELATED APPLICATIONS

This application is based upon and claims priority to Chinese Patent Application No. 2013106398770, titled “Television, and method and device for processing a play record thereof”, filed Dec. 2, 2013; Chinese Patent Application No. 2013106492185, titled “Television, and method and device for deleting content item thereof”, filed Dec. 6, 2013, the entire contents of which are incorporated herein by reference.

### FIELD OF TECHNOLOGY

The present disclosure generally relates to a technical field of televisions (TVs), and more particularly to a TV, and a method and a device for processing play histories in the TV.

### BACKGROUND

A smart TV is a new TV product which typically has a full open platform, and an operating system running thereon which enables a user to install and uninstall various application software by himself or herself during enjoyment of TV contents to continuously extend and update functions of the TV. Thus, the TV does not only receive cable TV signals to play TV programs passively, and a user may locally store multimedia files in the TV or connect an external storage device to the TV, and then the TV can play multimedia files selected by the user on his or her own initiative.

No matter the multimedia files are played using a TV or other players, it is desired to store and display the play histories, and thus the multimedia files may be operated directly according to the play histories without searching the multimedia files from the original storage positions. In order to meet such requirement, similarly to other players, TVs should provide play histories for user's operation.

However, as compared with other play tools such as personal computers, smart phones or personal digital assistant (PDA), though playing multimedia files using a TV may provide better visual experience and enhanced comfortableness during enjoyment of the multimedia files, the operation flexibility and information receiving capacity of the TV is far inferior to the personal computers, smart phones or PDAs, because the TV is usually operated by a remote control and the operation distance is relatively far. As a result, when operating the play histories on the TV, complicated and tedious operations are needed and thus user experience is influenced. Thus, a method applicable for processing TV play histories is needed to improve user experience.

There is no effective solution provided by related arts at present aiming at the above problem.

### SUMMARY

One of the objectives of embodiments of the present disclosure is to provide a method for processing play histories in a TV so as to solve the above problem that user experience is influenced when operating play histories on a TV.

According to an aspect of embodiments of the present disclosure, there is provided a method for processing play histories in a TV. The TV has a screen on which a timeline is displayed vertically, N points in time are displayed at one side of the timeline, each of the points in time corresponds to a play history set which includes one or more play histories. A play history set corresponding to an n-th point in time is displayed between the n-th point in time and an (n+1)-th point in time at the other side of the timeline, wherein 0<n<N−1. The method includes: receiving an operation command for the play histories sent from a user; detecting a position where an operation focus currently is; and processing the play histories according to the operation command and the position where the operation focus currently is.

According to another aspect, the processing the play histories according to the operation command and the position where the operation focus currently is, includes: if the operation focus is on a first play history, controlling a preset trash icon to be displayed in the same row as the first play history separately from a side of the timeline, wherein the first play history is any one of the play histories displayed on the screen of the TV; and after displaying the trash icon, if a first command for moving the operation focus and a confirmation command sent from the user are received, deleting the first play history, wherein the first command for moving the operation focus is configured to move the operation focus from the first play history onto the trash icon.

According to another aspect, there are at least the first play history and a second play history displayed on a display interface of the TV, the first play history is displayed at a first position on the display interface, the second play history is displayed at a second position on the display interface which is next to and in the same column as the first position, and the method further includes: after the first play history is deleted, switching a background control focus of the TV from the first play history to the second play history, wherein when the first play history is deleted, the control focus corresponds to the first play history; controlling the second play history to move from the second position to the first position for display; and in response to the confirmation command from the user, deleting the second play history corresponding to the control focus.

According to another aspect, the method further includes: if the operation focus is on the first position, switching the background control focus of the TV to the first play history; wherein the deleting the first play history includes: deleting the first play history corresponding to the control focus in response to the confirmation command.

According to another aspect, the deleting the first play history corresponding to the control focus in response to the confirmation command, includes: in response to the confirmation command, creating a second level window on the display interface, and displaying inquiry information on the second level window for inquiring the user as to whether deletion is confirmed; and after displaying the inquire information, in response to the confirmation command or if no user input command is received within a preset time period, deleting the first play history corresponding to the control focus.

According to another aspect, a history-emptying icon is further displayed on the screen of the TV, and the processing the play histories according to the operation command and the position where the operation focus currently is, includes: if the operation focus is on the history-emptying icon, and a confirmation command sent from the user is received, deleting all the play histories on the screen of the TV.

According to another aspect, the processing the play histories according to the operation command and the position where the operation focus currently is, includes: if the operation focus is on a second play history, and a confirmation command sent from the user is received, obtaining a time when watching of a multimedia file corresponding to the second play history is last ended, wherein the second play history is any one of the play histories displayed on the screen of the TV; enabling a play time of the multimedia file corresponding to the second play history to jump to the time when the watching of the multimedia file is last ended; and playing the multimedia file corresponding to the second play history from the time when the watching of the multimedia file is last ended.

According to another aspect, each of the play histories includes a thumbnail and a name of a multimedia file, thumbnails of respective multimedia files in respective play histories are displayed at one column, and names of multimedia files in respective play histories are displayed at one column, and the thumbnail and the name of a multimedia file of one play history are displayed in the same row.

According to another aspect, each of the play histories further includes a storage position, and storage positions of respective play histories are correspondingly displayed on respective thumbnails of multimedia files of respective play histories; and wherein types of the storage positions include local storage, external storage and non-existing, wherein when a multimedia file corresponding to a third play history is deleted from a local storage device or an external storage device, the storage position of the third play history is displayed as non-existing, wherein the third play history is any one of the play histories displayed on the screen of the TV.

According to another aspect of embodiments of the present disclosure, there is provided a device for processing play histories in a TV. The TV has a screen on which a timeline is displayed vertically, N points in time are displayed at one side of the timeline, each of the N points in time corresponds to a play history set which includes one or more play histories, among which a play history set corresponding to an n-th point in time is displayed between the n-th point in time and an (n+1)-th point in time at the other side of the timeline, wherein 0<n<N−1: wherein the device includes:

one or more processors; and

a memory;

wherein one or more programs are stored in the memory, and when executed by the one or more processors, the one or more programs cause the one or more processors to:

receive an operation command for the play histories sent from a user;

detect a position where an operation focus currently is; and

process the play histories according to the operation command and the position where the operation focus currently is.

According to another aspect, the one or more processors are configured to:

if the operation focus is on a first play history, control a preset trash icon to be displayed in the same row as the first play history separately from a side of the timeline, wherein the first play history is any one of the play histories displayed on the screen of the TV; and

after display the trash icon, if a first command for moving the operation focus and a confirmation command sent from the user are received, delete the first play history, wherein the first command for moving the operation focus is configured to move the operation focus from the first play history onto the trash icon.

According to another aspect, there are at least the first play history and a second play history displayed on a display interface of the TV, the first play history is displayed at a first position on the display interface, the second play history is displayed at a second position on the display interface which is next to and in the same column as the first position; and

the one or more processors are configured to:

after the first play history is deleted, switch a background control focus of the TV from the first play history to the second play history, wherein when the first play history is deleted, the control focus corresponds to the first play history;

control the second play history to move from the second position to the first position for display; and

in response to the confirmation command from the user, delete the second play history corresponding to the control focus.

According to another aspect, the one or more processors are further configured to, if the operation focus is on the first position, switch the background control focus of the TV to the first play history;

wherein the deleting of the first play history includes: deleting the first play history corresponding to the control focus in response to the confirmation command.

According to another aspect, the one or more processors are configured to:

in response to the confirmation command, create a second level window on the display interface, and display inquiry information on the second level window for inquiring the user as to whether deletion is confirmed; and

after display the inquire information, in response to the confirmation command or if no user input command is received within a preset time period, delete the first play history corresponding to the control focus.

According to another aspect, a history-emptying icon is further displayed on the screen of the TV, and the one or more processors are configured to:

if the operation focus is on the history-emptying icon, and a confirmation command sent from the user is received, delete all the play histories on the screen of the TV.

According to another aspect, the one or more processors are configured to:

if the operation focus is on a second play history, and a confirmation command sent from the user is received, obtain a time when watching of a multimedia file corresponding to the second play history is last ended, wherein the second play history is any one of the play histories displayed on the screen of the TV;

enable a play time of the multimedia file corresponding to the second play history to jump to the time when the watching of the multimedia file is last ended; and

play the multimedia file corresponding to the second play history from the time when the watching of the multimedia file is last ended.

According to another aspect, each of the play histories includes a thumbnail and a name of a multimedia file, thumbnails of respective multimedia files in respective play histories are displayed at one column, and names of multimedia files in respective play histories are displayed at one column, and the thumbnail and the name of a multimedia file of one play history are displayed in the same row.

According to another aspect, each of the play histories further includes a storage position, and storage positions of respective play histories are correspondingly displayed on respective thumbnails of multimedia files of respective play histories; and

wherein types of the storage positions include local storage, external storage and non-existing, wherein when a multimedia file corresponding to a third play history is deleted from a local storage device or an external storage device, the storage position of the third play history is displayed as non-existing, wherein the third play history is any one of the play histories displayed on the screen of the TV.

According to another aspect of embodiments of the present disclosure, there is provided a TV including a device for processing play histories in the TV, wherein the TV has a screen on which a timeline is displayed vertically, N points in time are displayed at one side of the timeline, each of the N points in time corresponds to a play history set which includes one or more play histories, among which a play history set corresponding to an n-th point in time is displayed between the n-th point in time and an (n+1)-th point in time at the other side of the timeline, 0<n<N−1: wherein the device includes:

one or more processors; and

a memory;

wherein one or more programs are stored in the memory, and when executed by the one or more processors, the one or more programs cause the one or more processors to:

receive an operation command for the play histories sent from a user;

detect a position where an operation focus currently is; and

process the play histories according to the operation command and the position where the operation focus currently is.

According to another aspect of embodiments of the present disclosure, there is provided a computer readable recording medium, on which programs for performing a method for processing play histories in a TV are recorded, wherein the TV has a screen on which a timeline is displayed vertically, N points in time are displayed at one side of the timeline, each of the N points in time corresponds to a play history set which includes one or more play histories, among which a play history set corresponding to an n-th point in time is displayed between the n-th point in time and an (n+1)-th point in time at the other side of the timeline, 0<n<N−1, wherein the method includes:

receiving an operation command for the play histories sent from a user;

detecting a position where an operation focus currently is; and

processing the play histories according to the operation command and the position where the operation focus currently is.

According to another aspect of embodiments of the present disclosure, there is provided a device for processing play histories in a TV. The TV has a screen on which a timeline is displayed vertically, N points in time are displayed at one side of the timeline, each of the N points in time corresponds to a play history set which includes one or more play histories, among which a play history set corresponding to an n-th point in time is displayed between the n-th point in time and an (n+1)-th point in time at the other side of the timeline, wherein 0<n<N−1. The device includes: a receiving module configured to receive an operation command for the play histories sent from a user; a detecting module configured to detect a position where an operation focus currently is; and a processing module configured to process the play histories according to the operation command and the position where the operation focus currently is.

According to another aspect of embodiments of the present disclosure, there is provided a device for processing play histories in a TV. The device is configured to perform any one of the methods for processing play histories in a TV provided by the present disclosure.

According to another aspect of embodiments of the present disclosure, there is provided a TV which includes any one of the devices for processing play histories in the TV provided by the present disclosure.

According to another aspect of embodiments of the present disclosure, there is provided a computer readable recording medium, on which programs for performing any one of the methods provided by the present disclosure are recorded.

In the embodiments of the present disclosure, a timeline is displayed vertically on a screen of a TV, respectively stored play histories are displayed in a form of timeline, points in time are displayed at one side of the timeline, and the play histories are displayed at the other side of the timeline. Further, the play histories are presented to users from top to bottom along a vertical direction on the screen of the TV. When processing the play histories, the TV receives an operation command for the play histories sent from a user, detects a position where an operation focus currently is, and processes the play histories according to the operation command and the position where the operation focus currently is. Thus, operating the play histories on the TV by the user becomes simple, and thereby user experience is improved.

The above illustration is only a general description of the technical solutions provided by the present disclosure, aiming at making the technical means of the present disclosure understood more clearly and thereby practiced based on the contents of the specification. Further, in order to make the above and other objects, features and advantages of the present disclosure more obvious, specific implementations of the present disclosure will be exemplified below.

### BRIEF DESCRIPTION OF THE DRAWINGS

One of ordinary skill in this art will appreciate other advantages from the following detailed descriptions of exemplary embodiments herein. Drawings are only for showing exemplary embodiments but not for limiting the scope of the present disclosure. Through the drawings, similar reference numbers represent similar elements.

FIGS. 1(a) to 1(h) are schematic diagrams showing operations on play histories in a TV according to the present disclosure;

FIG. 2 is a flowchart showing a method for processing play histories in a TV according to a first embodiment of the present disclosure;

FIG. 3 is a flowchart showing a method for processing play histories in a TV according to a second embodiment of the present disclosure;

FIG. 4 is a flowchart showing a method for processing play histories in a TV according to a third embodiment of the present disclosure;

FIGS. 5(a) to 5(e) are schematic diagrams showing a method for processing play histories in a TV according to a fourth embodiment of the present disclosure;

FIG. 6 is a flowchart showing a method for processing play histories in a TV according to a fourth embodiment of the present disclosure;

FIG. 7 is a block diagram showing a device for processing play histories in a TV according to a fifth embodiment of the present disclosure; and

FIG. 8 is a block diagram showing a device for processing play histories in a TV according to a sixth embodiment of the present disclosure.

### DESCRIPTION OF THE EMBODIMENTS

The present disclosure will be described below in detail with reference to drawings and specific implementations. It shall be pointed out that the embodiments and features in embodiments of the present disclosure may be combined with each other if they do not conflict.

In embodiments of the present disclosure, methods for processing respective play histories are based on the following display pattern for play histories on a TV. Specifically, when a user starts a page for processing play histories, for example, the user clicks a “Play Histories” icon to enter into a play history list, a timeline is displayed vertically on the screen of the TV. A plurality of points in time are displayed at one side of the timeline, for example, the left side, and one or more play histories are displayed at the other side of the timeline, for example, the right side. One point in time corresponds to a play history set which includes one or more play histories. At a position between an n-th point in time and an (n+1)-th point in time, a play history set corresponding to the n-th point in time is displayed, wherein 0<n<N−1.

A play history refers to play information regarding a multimedia file, and may include a date when the multimedia file is played, a thumbnail of the multimedia file, a name of the multimedia file, a time when watching of the multimedia file is ended, a storage position of the multimedia file, and the like.

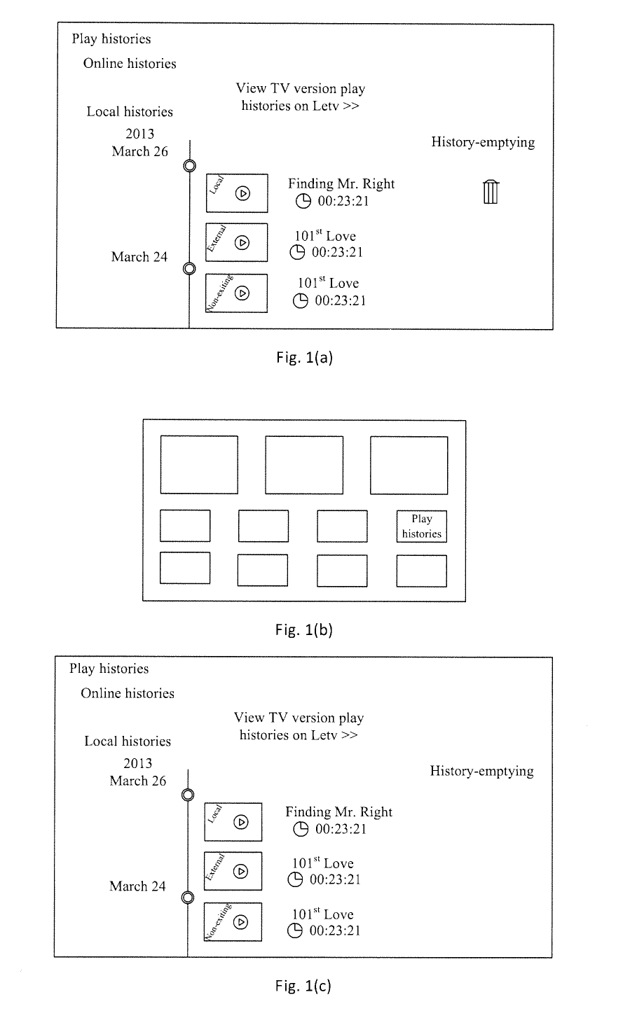

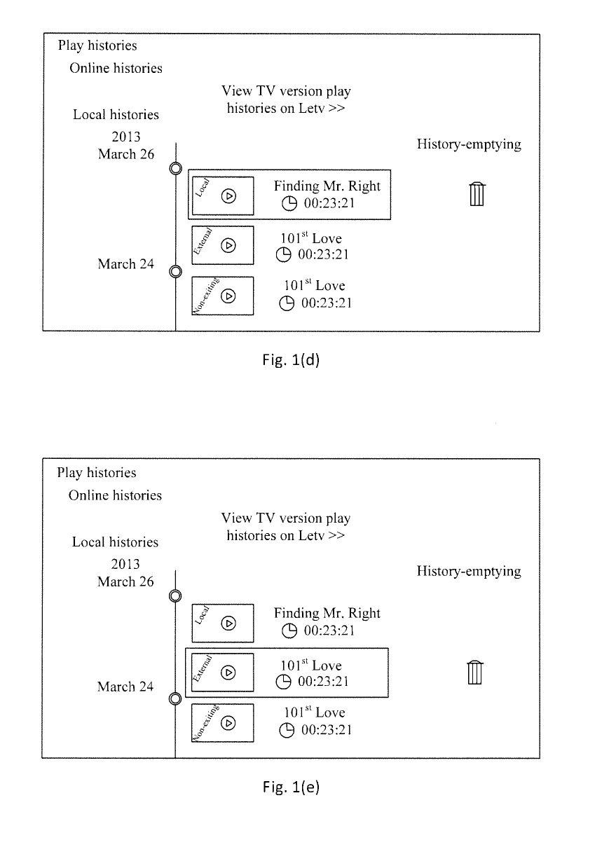

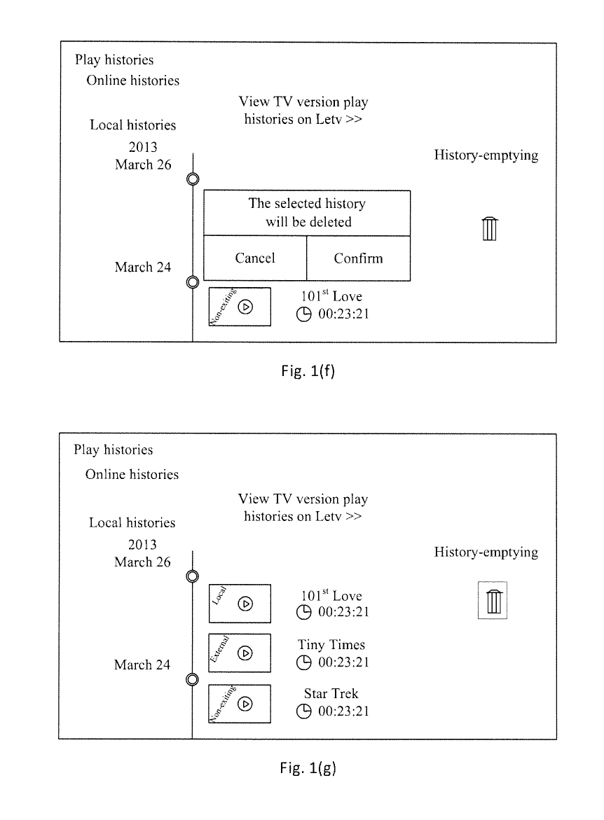

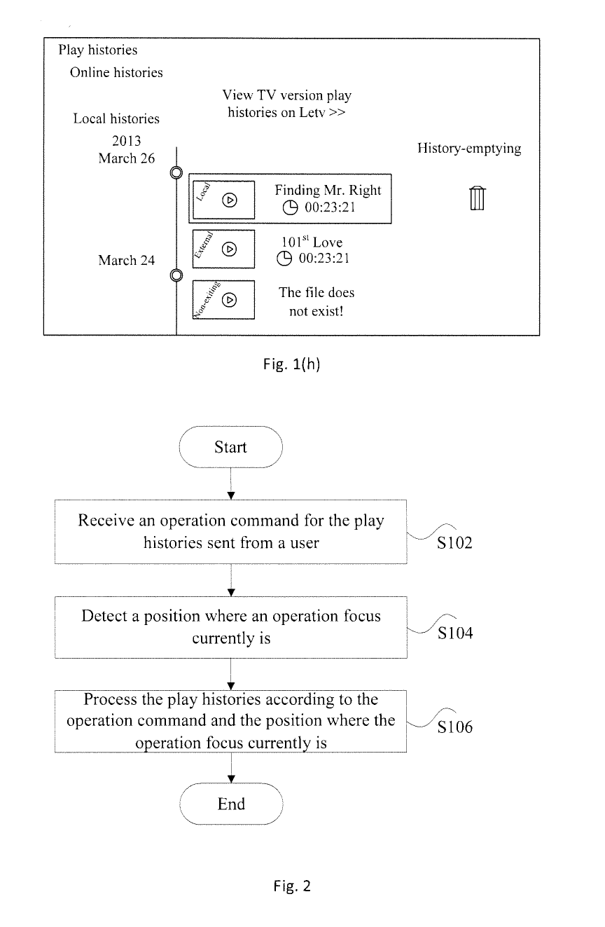

As shown in FIG. 1(a), two points in time are displayed at the left side of a timeline, i.e., a first point in time which is shown as Mar. 26, 2013 and a second point in time which is shown as March 24. A plurality of play histories are displayed at the right side of the timeline. A play history set corresponding to the first point in time includes two play histories displayed between the first point in time and the second point in time. A play history set corresponding to the second point in time includes one play history displayed below the second point in time.

With respect to the play histories in a TV, the present disclosure provides the following embodiments of methods for processing the play histories. Detailed descriptions are as follows.

### First Embodiment

The first embodiment of the present disclosure provides a method for processing play histories in a TV. Referring to FIG. 2, the method may include the following steps.

In step S102, an operation command for the play histories sent from a user is received.

After a user starts a page for processing play histories, the TV may display a page as shown in FIG. 1(a). The user may input operation commands on the page by using a signal transmitting device of the TV, for example, by a remote control of the TV. The operation commands here include commonly used commands when operating the remote control, for example, commands for moving an operation focus sent by direction buttons such as “up”, “down”, “left”, “right”, “+” or “−”, or confirmation commands sent by a “Confirm” button.

In step S104, a current position of the operation focus is detected.

After receiving a command from the remote control, the position of the operation focus on the current page is detected. The operation focus may be at a default operation focus position when the current page is open, or on a certain play history, or on a certain point in time.

In step S106, the play histories are processed according to the operation command and the position of the operation focus.

By this step, an object to be processed (i.e., the object controlled by the operation command, for example, a certain play history) is determined according to the position of the operation focus. Then, the process manner is determined according to the operation command, i.e., what process shall be performed on the play history.

For example, if it is detected that the current operation focus is on a certain play history A, and a confirmation command sent from the user is received (i.e., the user presses the “Confirm” button on the remote control), when processing the play history A, the time when watching of a multimedia file corresponding to the play history A is last ended is firstly obtained, for example, by inquiring the play log of the TV, then a player is started to enable a play time of the multimedia file corresponding to the play history A to jump to the time when watching of the multimedia file is last ended, and the player is controlled to play the multimedia file corresponding to the play history A from the obtained time when watching of the multimedia file is last ended.

In the above procedure, from the view of the user side, when the user wants to watch a certain multimedia file from the time when watching of the multimedia file is last ended, he/she only needs to start the page for processing play histories, move the operation focus to the play history corresponding to the multimedia files using direction buttons, and press the “Confirm” button, and then the TV may automatically play the multimedia file from the position where the multimedia file is last played. The user operations are simple, fast and thus the user can have a better experience.

When moving the operation focus to the play history corresponding to the multimedia file, since the play histories are arranged in the same column, the user only needs to press the “up” or “down” button. Further, the operation focus may be firstly moved to a point in time, the point in time is determined by relatively less number of operations, and then the play history may be found under the point in time.

As an example, a history-emptying icon as shown in FIG. 1(a) may be displayed on the screen of the TV. The operation object corresponds to the icon includes all the play histories. If the operation focus is on the history-emptying icon, and a confirmation command sent from the user is received (i.e., the user presses the “Confirm” button on the remote control), all the play histories displayed on the screen are deleted.

In the above procedure, from the view of the user side, when the user wants to delete all the play histories, he/she only needs to start the page for processing play histories, move the operation focus to the history-emptying icon by direction buttons, and press the “Confirm” button, and then the TV may automatically delete all the play histories. The user operations are simple and fast and thus the user may have a better experience.

In conclusion, play histories in a TV provided by the present disclosure are displayed in the same column in a form of timeline. Using the method for processing play histories in a TV provided by the present embodiment, the play histories are processed according to user operation commands and the positions of the operation focus, and the user only needs to input simple operation commands for the purposes of operating play histories. Thus, a relatively simple manner for operating the play histories in the TV is provided for the user, and thereby user experience is improved.

### Second Embodiment

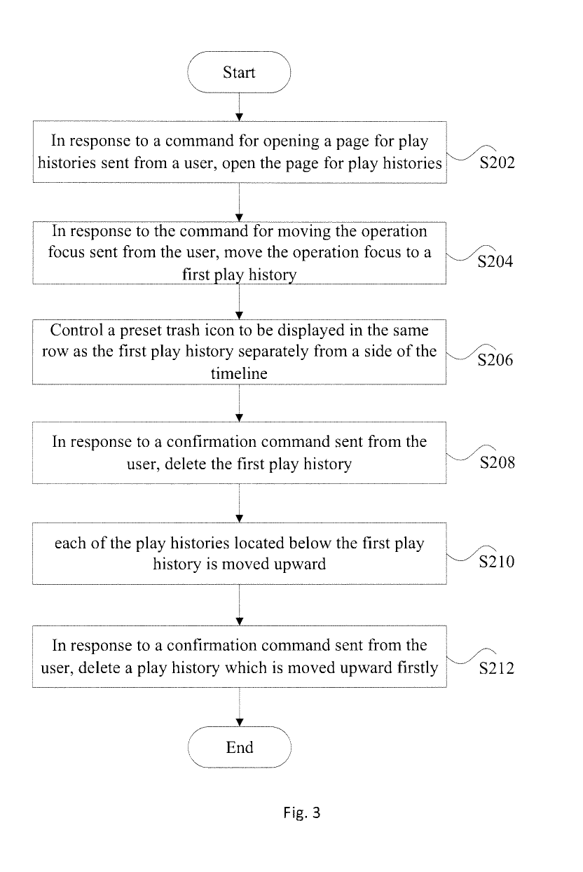

On the basis of the first embodiment, the present embodiment provides a further improved method for processing play histories in a TV. Referring to FIG. 3, the method may include the following steps.

In step S202, in response to a command for opening a page for play histories sent from a user, the page for play histories is opened.

On a desktop composed of a plurality of applications, after a user selects “Play Histories” and presses the “Confirm” button to enter into an application regarding play histories, the TV opens a page for play histories, as shown in FIG. 1(b) or (c).

As shown in FIG. 1(c), after the page for play histories is open, the operation focus stays at “View TV version play histories on Letv” by default. The user may move the operation focus by a command for moving the operation focus.

In step S204, in response to the command for moving the operation focus sent from the user, the operation focus is moved to a first play history.

In step S206, a preset trash icon is controlled to be displayed in the same row as the first play history separately from a side of the timeline.

The user may send a command to the TV for moving the operation focus by direction buttons, as shown in FIG. 1(d). In response to the command, the TV moves the operation focus to a first play history. The name of a multimedia file corresponding to the play history is “Finding Mr. Right”.

Meanwhile, when the operation focus is on the play history, as shown in FIG. 1(d), a preset trash icon is displayed in the same row as the first play history and at the right side of the first play history.

When the operation focus moves to a second play history, i.e., a play history corresponding to a multimedia file with the name of “101^{st} Love”, as shown in FIG. 1(e), the preset trash icon is displayed in the same row with the second play history and at the right side of the second play history.

In step S208, in response to a confirmation command sent from the user, the first play history is deleted.

As shown in FIG. 1(f), for the play history corresponding to “Finding Mr. Right”, when the operation focus is on the trash icon and a confirmation command sent from the user is received, firstly, a dialog box is popped up to notify the user that the selected history will be deleted, and after the user confirms again, the play history is deleted.

In step S210, each of the play histories located below the first play history is moved upward.

In step S212, in response to a confirmation command sent from the user, a play history which is moved upward firstly is deleted.

As shown in FIG. 1(g), after the play history corresponding to “Finding Mr. Right” is deleted, the TV automatically move the play histories corresponding to “101^{st} Love” and “Star Trek” upward which are located below the play history corresponding to “Finding Mr. Right”.

After moving upward, the trash icon still stays at the original position, and however the play history corresponding to the trash icon becomes the play history corresponding to “101^{st} Love”. At this time, if a confirmation command sent from the user is received again, the TV directly deletes the play history corresponding to “101^{st} Love”. Similarly, after the play history corresponding to “101^{st} Love” is deleted, the TV automatically moves the play history corresponding to “Star Trek” upward which is located below the play history corresponding to “101^{st} Love”.

In this way, if the user wants to continuously delete a plurality of play histories, he/she only needs to move the operation focus to the trash icon and continuously click the “Confirm” button.

Optionally, each of the play histories includes a thumbnail and a name of a multimedia file, as shown in the figures in FIG. 1. Thumbnails of respective multimedia files in respective play histories are displayed at one column, and names of multimedia files in respective play histories are displayed at one column, and the thumbnail and the name of a multimedia file of one play history are displayed in the same row.

Optionally, each of the play histories further includes a storage position, and the storage positions of respective play histories are correspondingly displayed on respective thumbnails of multimedia files of respective play histories. The types of storage positions include local storage, external storage and non-existing. When a multimedia file corresponding to a certain play history is deleted from a local storage device or an external storage device, the storage position of the play history is displayed as non-existing. When the user operates the play history, i.e., when an operation command sent from the user is received and the operation focus is on the play history, notification information is displayed, as shown in FIG. 1(h), to notify the user that “No file exists!”. The notification is presented for seconds and then automatically disappears.

### Third Embodiment

On the basis of the second embodiment, the present embodiment provides a further improved method for processing play histories in a TV. The method mainly relates to the procedure for deleting a plurality of play histories by the TV. In the embodiment, for example, two play histories are deleted at the same time.

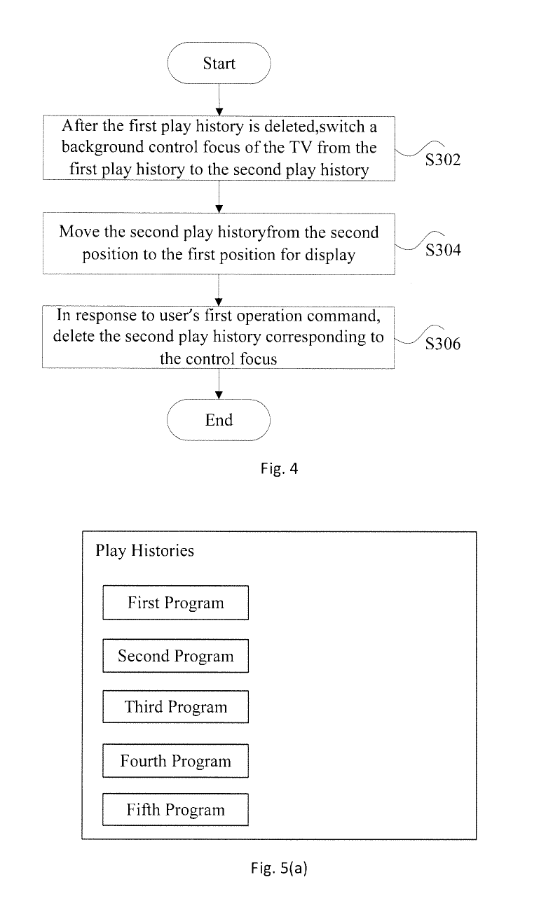

After a user opens a page for play histories, as shown in FIG. 1(c), a first play history (corresponding to “Finding Mr. Right”) and a second play history (corresponding to “101^{st} Love”) are displayed on a display interface of the TV. The first play history is displayed at a first position on the display interface, and the second play history is displayed at a second position, which is different from the first position, on the display interface. Referring to FIG. 4, the method may include the following steps.

In step 302, after the first play history is deleted, a background control focus of the TV is switched from the first play history to the second play history.

The control focus here refers to a focus of actual controls performed by the background of the TV. The focus is not displayed on the display interface to the user and thus is different from the operation focus on the display interface. The latter refers to a focus which can be viewed by the user from the display interface, for example, a little arrow when a mouse is moved, or a representation of an operation corresponding to a remote control.

In the present disclosure, when a user inputs an operation command, the TV applies the operation command to a play history corresponding to the current control focus. Thus, when a first play history is deleted, the control focus corresponds to the first play history, i.e., the controls are focused on the first play history. After the first play history is deleted, the TV automatically switches the control focus to a second play history. By the step S302, controls are focused on the second play history.

In step S304, the second play history is moved from the second position to the first position for display.

Since the switching of the background control focus cannot be displayed to the user in real time, and the switching of the control focus is performed automatically but not manually triggered by the user, the user cannot know which play history serves as the current operation object after the first play history is deleted from the view of the user. In order to make the user know the current operation object in real time and reduce user's operations, by the step S304, after the controls are focused on the second play history, the TV automatically moves the second play history to the position where the first play history was before deletion. Thus, the user may know that the current operation object has become the second play history.

In step S306, in response to user's first operation command, the second play history corresponding to the control focus is deleted.

The first operation command here is configured to send a control signal for deletion to the TV, and may be set according to the type of a signal generation device. For example, if the signal generation device is a remote control, a deletion button may be set on the remote control. After the user presses the deletion button, the first operation command is sent. When the signal generation device is a smart phone connected with the TV, a command input box is set on the phone. After “Delete” is input by the user into the input box and then is sent, the first operation command is sent. Or, the first operation command may be sent using other methods or other types of signal generation devices, and the present disclosure does not impose specific limitations on this.

In a word, after the user sends the operation command, the TV parses and responds to the command. After parsing, if the command is a command for deletion, and the controls are currently focused on the second play history, a deletion process is performed on the second play history to delete the second play history, i.e., the play history corresponding to “101^{st} Love” is deleted.

If a third play history is also displayed on the display interface, concurrently with the moving of the second play history from the second position to the first position, the third play history is moved from the third position to the second position for display. After the second play history is deleted, the third play history is moved from the second position to the first position for display. Or, when the second play history is moved from the second position to the first position, the position of the third play history may keep unchanged, and after the second play history is deleted, the third play history is moved from the third position to the first position for display. No matter which moving method is employed, after the second play history is deleted, the control focus will be switched from the second play history to the third history. At this time, if the user inputs the first operation command again, the TV will delete the third play history on which controls are focused.

In similar manners, when more than three play histories are displayed on the display interface, in the method for deleting play histories in TV provided by the present embodiment, the user does not need to select the play histories to be deleted one by one, and he/she only needs to send a control signal for deletion for once.

Using the method for processing play histories in a TV provided by the embodiment, the objects of the deletion operation performed by the TV is the play histories corresponding to the background control focus. By automatically switching the play histories corresponding to the control focus instead of manual selecting by the user, the operation steps which need to be performed by the user to delete a plurality of play histories are reduced. Thus, the deletion of play histories in the TV by the user becomes more convenient and thereby user experience is improved.

### Fourth Embodiment

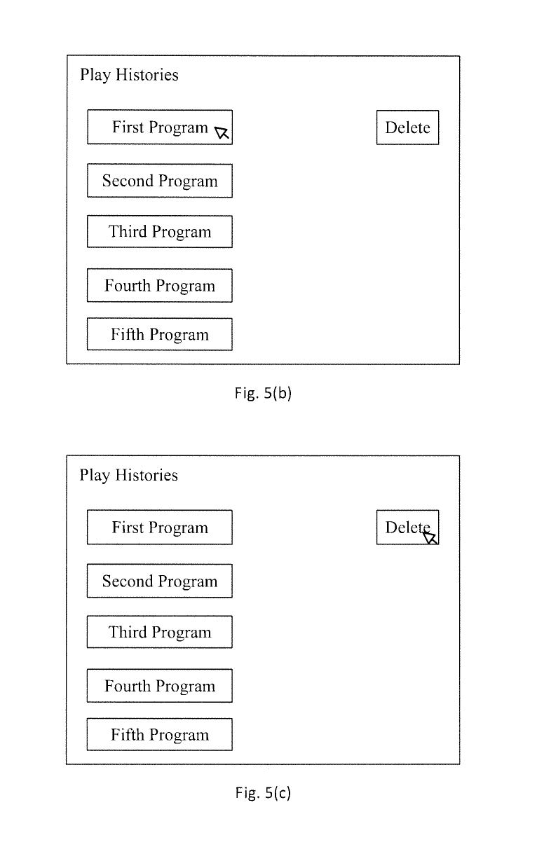

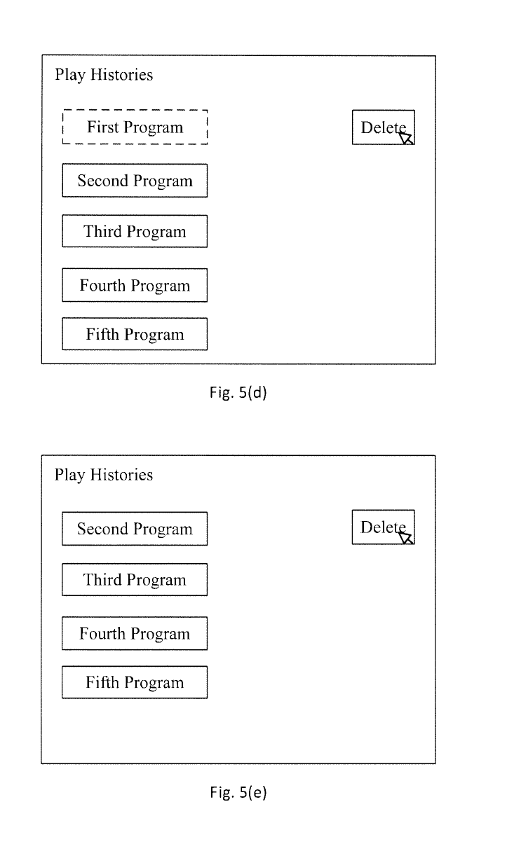

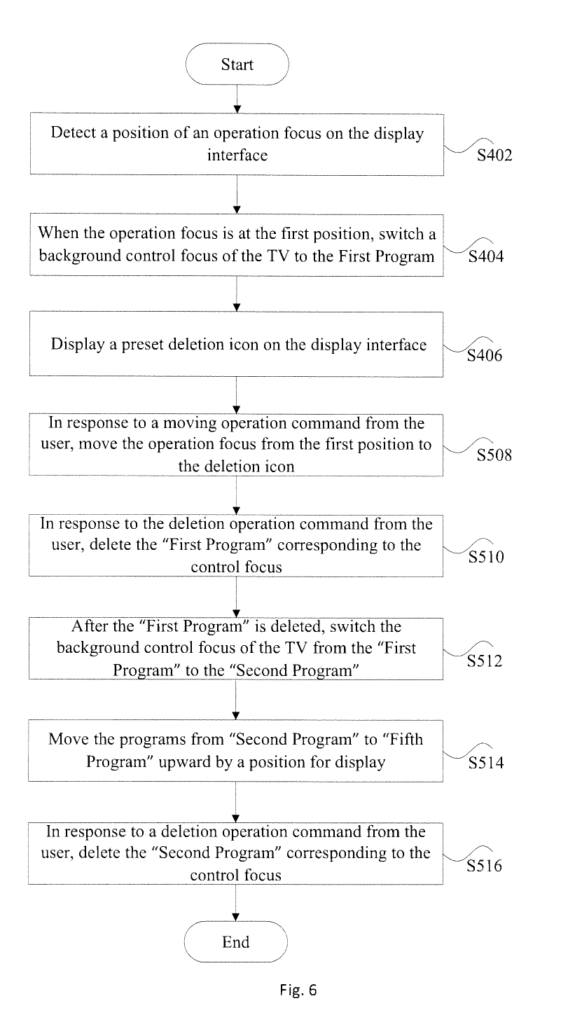

On the basis of the third embodiment, the present embodiment provides a further improved method for processing play histories in a TV, as shown in FIGS. 5(a) to 5(e). Referring to FIG. 5(a), the play histories include five content items, i.e., “First Program” to “Fifth Program”. The five programs are displayed at the first to fifth position in the same column on the display interface, respectively. Referring to FIG. 6, the method may include the following steps.

In step S402, a position of an operation focus on the display interface is detected.

After a user opens a page for displaying play histories, the display interface of the TV may be a page as shown in FIG. 5(a). At this time, the user may perform operations via a signal generation device such as a remote control, and then the TV detects the position of the operation focus in real time to obtain the object operated by the user.

In step S404, when the operation focus is at the first position, a background control focus of the TV is switched to the First Program.

In step S406, a preset deletion icon is displayed on the display interface.

As shown in FIG. 5(b), when it is detected that the operation focus (as indicated by the arrow in the figure) is at the first position, i.e., on the “First Program”, firstly, the TV switches the background control focus to the “First Program”. When the user sends an operation command at this time, the TV performs operations on the “First Program” on which controls are focused on.

Concurrently with locating the control focus on the “First Program”, the preset deletion icon is displayed at a position in the same row with the “First Program” to notify the user to perform a deletion operation on the “First Program”.

In step S508, in response to a moving operation command from the user, the operation focus is moved from the first position to the deletion icon.

As shown in FIG. 5(c), the user may perform the moving operation using a signal generation device such as a remote control. For example, the user sends the moving operation command by direction buttons on the remote control, and the TV moves the operation focus to the deletion icon in response to the moving operation command.

In step S510, in response to the deletion operation command from the user, the “First Program” corresponding to the control focus is deleted.

As shown in FIG. 5(d), the user may perform the deletion operation using a signal generation device such as remote control. For example, when the operation focus is on the deletion icon, the user sends the deletion operation command using a confirmation button on the remote control. The TV deletes the “First Program” in response to the deletion operation command.

In step S512, after the “First Program” is deleted, the background control focus of the TV is switched from the “First Program” to the “Second Program”.

In step S514, the programs from “Second Program” to “Fifth Program” are moved upward by a position for display.

As shown in FIG. 5(e), after the “First Program” is deleted, the controls are focused on the “Second Program”. At this time, if the user sends an operation command, the TV performs operations on the “Second Program” on which controls are focused.

Concurrently with switching the control focus to “Second Program”, programs from the “Second Program” to the “Fifth Program” are moved upward by a position. At this time, the “Second Program” is located at the position where the “First Program” was, and is displayed in the same row as the deletion icon to notify the user that he/she may perform a deletion operation on the “Second Program”.

In step S516, in response to a deletion operation command from the user, the “Second Program” corresponding to the control focus is deleted.

The user may perform the deletion operation using a signal generation device such as a remote control. For example, the user may press a confirmation button on the remote control to send a deletion operation command. In response to the deletion operation command, the TV deletes the “Second Program”.

In the similar manners, after the “Second Program” is deleted, the background control focus of the TV is switched from the “Second Program” to the “Third Program”, and the programs from the “Third Program” to the “Fifth Program” are moved upward by a position for display. At this time, the “Third Program” can be deleted. Repeated descriptions regarding the deletion procedure will not be elaborated here.

When the user is intended to delete the “First Program”, the “Third Program” and the “Fourth Program”, after the “First Program” is deleted, the programs from the “Second Program” to the “Fifth Program” are moved upward by a position for display, and the “Third Program” is located at the second position. At this time, the user may move the operation focus to the second position (i.e., a position where the “Third Program” currently is) by a moving operation command. After detecting that the operation focus is on the second position, the TV switches the background control focus of the TV to the “Third Program”, and controls a deletion icon to be displayed at a position in the same row as the “Third Program” to notify the user that he/she may perform a deletion operation on the “Third Program”. After the “Third Program” is deleted, the “Fourth Program” and the “Fifth Program” are moved upward by a position for display, and at this time, controls are focused on the “Fourth Program”, and the user may perform operation steps on the “Fourth Program”. Repeated descriptions will not be elaborated here.

In the above procedure, the user may also perform a play operation. For example, when the operation focus is on a certain program, and the user presses the confirmation button on the remote control, the TV plays the program.

In the method for processing play histories in a TV provided by the present embodiment, a play history to be firstly deleted is obtained by detecting the position of the operation focus. For example, if it is detected that the operation focus is on a certain play history, the controls are automatically focused on the play history, so that the user may directly send operation commands to operate the play history. Thus, operations are simple and convenient.

By providing a preset deletion icon, a visual operation object is provided to the user, so that the user can have an intuitive operation feedback. Thus, user experience is further improved. The deletion icon here may be realized by the above-described trash icon.

Displaying the preset deletion icon in the same row as the currently operated play history is convenient for the user to operate. For example, when the user moves the operation focus between the play histories and the deletion icon by the remote control, he/she only needs to press the direction buttons such as “left” and “right”.

In order to avoid deleting a play history inadvertently by the user, optionally, a second level window may be displayed to get further confirmation from the user before deletion of any program. Specifically, taking the deletion of the “First Program” as an example, the step S510 includes: in response to the user's deletion operation command, firstly creating a second level window on the display interface, and displaying inquiry information on the second level window for inquiring the user as to whether deletion is confirmed; and after the user inputting a command to confirm deletion or if no user input command is received within a preset time period (for example, five seconds), deleting the “First Program” corresponding to the control focus. By this embodiment, inadvertent deletion by the user can be avoided.

The above descriptions relate to the methods for processing play histories in a TV provided by the present disclosure, and the devices for processing play histories in a TV provided by the present disclosure will be described below. It shall be noted that the devices may be configured to perform any one of the above methods for processing play histories in a TV.

### Fifth Embodiment

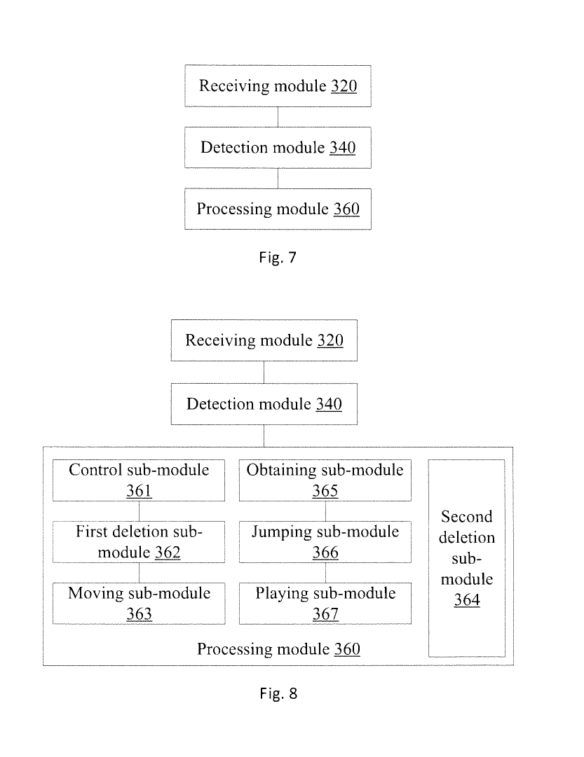

Corresponding to the method for processing play histories in a TV provided by the first embodiment, the embodiment of the present disclosure further provides a device for processing play histories in a TV. The device is disposed in a TV. Referring to FIG. 7, the device may include a receiving module 320, a detection module 340 and a processing module 360.

The receiving module 320 is configured to receive an operation command for the play histories sent from a user. An icon of an application for play histories is displayed on a page for an application list of the TV. A user may locate an operation focus on the icon for play histories, and press a confirmation button. Then, the TV starts a page for processing play histories, as shown in FIG. 1(a). On the page, the TV receives an operation command for the play histories sent from a user by the receiving module 320.

Specifically, the receiving module 320 receives signals sent from a signal sending control device of the TV, for example, receiving the signals sent from a remote control, and the user inputs operation commands by the remote control. The operation commands here include commonly used commands when operating the remote control, for example, commands for moving an operation focus sent by direction buttons such as “up”, “down”, “left”, “right”, “+” or “−”, or confirmation commands sent by a “Confirm” button.

After the receiving module 320 receives the commands from the remote control, the detection module 340 detects a position on the displayed page of the TV where an operation focus currently is. The operation focus may be at a default operation focus position when the current page is open, or on a certain play history, or on a certain point in time.

The processing module 360 is configured to process the play histories according to the operation command and the position where the operation focus currently is. By the processing module, an object to be processed (i.e., the object controlled by the operation command, for example, a certain play history) is determined according to the position of the operation focus. Then, the process manner is determined according to the operation command, i.e., what process shall be performed on the play history.

The play histories in a TV provided by the present disclosure are displayed in the same column in a form of timeline. Using the device for processing play histories in a TV provided by the present embodiment, the play histories are processed according to user operation commands and the positions of the operation focus, and the user only needs to input simple operation commands for the purposes of operating play histories. Thus, a relatively simple manner for operating the play histories in the TV is provided for the user, and thereby user experience is improved.

### Sixth Embodiment

On the basis of the fifth embodiment, the present embodiment provides a further improved device for processing play histories in a TV. Referring to FIG. 8, the device may include a receiving module 320, a detection module 340 and a processing module 360. The processing module 360 includes a control sub-module 361, a first deletion sub-module 362, a moving sub-module 363, a second deletion sub-module 364, an obtaining sub-module 365, a jumping sub-module 366 and a playing sub-module 367.

In the embodiment, each of the play histories includes a thumbnail and a name of a multimedia file and a storage position, as shown in the drawings in FIG. 1. Thumbnails of respective multimedia files in respective play histories are displayed at one column, and names of multimedia files in respective play histories are displayed at one column, and the thumbnail and the name of a multimedia file of one play history are displayed in the same row.

Storage positions of respective play histories are correspondingly displayed on respective thumbnails of multimedia files of respective play histories. The types of storage positions include local storage, external storage and non-existing. When a multimedia file corresponding to a certain play history is deleted from a local storage device or an external storage device, the storage position of the play history is displayed as non-existing. When the user operates the play history, i.e., when an operation command sent from the user is received and the operation focus is on the play history, notification information is displayed.

Further, on the same page on which play histories are displayed in a form of timeline, a history-emptying icon is also displayed. The history-emptying icon is configured to delete all the play histories on the page in response to a confirmation command input by the user.

The receiving module 320 is configured to receive an operation command for the play histories sent from a user. The operation command for the play histories includes a command for moving an operation focus and a confirmation command. The detection module 340 detects a position on the displayed page of the TV where an operation focus currently is. The operation focus may be on a certain play history, or on the history-emptying icon, or other icon displayed during user's operations. The processing module 360 correspondingly processes the play histories according to the position of the operation focus and the operation command. Specifically, the processing module 360 may process the play histories by the following approaches.

When the operation focus is on a certain play history A, the control sub-module 361 controls a preset trash icon to be displayed in the same row as the play history A separately from a side of the timeline, and meanwhile switches a background control focus of the TV to the play history A. The play history A may be any one of the play histories displayed on the screen of the TV. The control focus here refers to a focus of actual controls performed by the background of the TV. The focus is not displayed on the display interface to the user and thus is different from the operation focus on the display interface. The operation focus refers to a focus which can be viewed by the user from the display interface, for example, a little arrow when a mouse is moved, or a representation of an operation corresponding to a remote control.

After displaying the trash icon, if a first command for moving the operation focus and a confirmation command sent from the user are received, the first deletion sub-module 362 deletes the play history A corresponding to the control focus. The first command for moving the operation focus here is configured to move the operation focus from the play history A onto the trash icon. For example, the timeline is at the right side of the play history, and then the trash icon is at the right side of the play history A. The command for moving from the play history A to the trash icon may be issued by means of pressing the button “left” by the user.

In the above procedure, from the view of the user side, when the user wants to delete a certain play history, he/she may press direction buttons to move the operation focus to the play history, and after the trash icon appears, move the operation focus to the trash icon by the direction buttons and then press the “Confirm” button. Then, the TV can delete the play history on which controls are focused, and user operations are simple and convenient and thereby user experience is improved.

Further, after the play history A is deleted, the moving sub-module 363 automatically moves respective play histories upward which are below the play history A, and switches the control focus from the play history A to an adjacent play history B below the play history A. After upward moving of the play histories, if the receiving module 320 receives a confirmation command sent from the user again, the first deletion sub-module 362 deletes a play history which is moved upward firstly, i.e., the play history B on which controls are focused currently. After deletion, the moving sub-module 363 moves the play histories upward again. If the receiving module 320 receives a confirmation command again, the first deletion sub-module 362 performs the deletion operation again. In this way, play histories are deleted until the user does not send the confirmation command again.

In the present disclosure, when the user inputs an operation command, the TV applies the operation command to a play history corresponding to the current control focus. Thus, when the play history A is deleted, the control focus corresponds to the play history A, i.e., the controls are focused on the play history A. After the first play history A is deleted, the moving sub-module 363 automatically switches the control focus to the play history B, thereby controls being focused on the play history B.

Since the switching of the background control focus cannot be displayed to the user in real time, and the switching of the control focus is performed automatically but not manually triggered by the user, the user cannot know which play history serves as the current operation object after the play history A is deleted from the view of the user. In order to make the user know the current operation object in real time and reduce user's operations, after the controls are focused on the play history B, the moving sub-module 363 automatically moves the play history A to the position where the play history B was before deletion. Thus, the user may know that the current operation object has become the play history B.

In the above procedure, from the view of the user side, if the user is intended to delete some play histories, he/she may move the operation focus to the play histories by direction buttons, and after the trash icon appears, move the operation focus to the trash icon by the direction buttons, and the control focus is switched automatically. Next, the only thing what needs the user to do is to continuously press the “Confirm” button. Then, the TV may delete the play histories one by one. The objects on which the deletion operation is performed by the TV are play histories corresponding to the background control focus. By automatically switching the control focus instead of manually selecting play histories by the user, the operations steps performed by the user when deleting a plurality of play histories are reduced. Thus, the deletion of play histories in a TV by the user becomes more convenient, and thereby user experience is improved.

When the user needs to delete all the play histories, in order to further simplify the user operations, if the operation focus is on the history-emptying icon and a confirmation command sent from the user is received, the second deletion sub-module 364 directly deletes all the play histories on the screen of the TV.

In the above procedure, from the view of the user side, when the user is intended to delete all the play histories, what the user needs to do is to start a page for processing play histories, move the operation focus to the history-emptying icon by direction buttons, and then press the “Confirm” button. Then, the TV may automatically delete all the play histories. The operations are simple and convenient.

The deletion procedures for deleting one or more or all of the play histories are described above. When the user wants to watch a multimedia file corresponding to a play history B, the processes performed by the processing module 360 are as follows. The play history B is any one of the play histories.

When the operation focus is on the play history B and a confirmation command sent from the user is received, the obtaining sub-module 365 obtains a time when watching of the multimedia file corresponding to the play history B is last ended, then the jumping sub-module 366 enables a play time of the multimedia file corresponding to the play history B to jump to the time when the watching of the multimedia file is last ended, and then the playing sub-module 367 plays the multimedia file corresponding to the play history B from the time when the watching of the multimedia file is last ended.

In the above procedure, from the view of the user side, when the user is intended to watch a certain multimedia file from a position where the multimedia file is last ended, what the user needs to do is to start a page for processing play histories, move the operation focus to the play history corresponding to the multimedia file by direction buttons, and then press the “Confirm” button. Then, the TV may continue to play the multimedia file from the position where the multimedia file is last played. The user operations are simple and convenient.

When moving the operation focus to the play history corresponding to the multimedia file, since the play histories are arranged in the same column, the user only needs to press the “up” or “down” button. Further, the operation focus may be firstly moved to a point in time, the point in time is determined by relatively less number of operations, and then the play history may be found under the point in time.

In order to avoid deleting a play history inadvertently by the user, optionally, a second level window may be displayed to get further confirmation from the user before deletion of any program. Specifically, the first deletion sub-module 362 includes two response modules. When the operation focus is on the trash icon and the user inputs a confirmation command, the first response modules creates a second level window on the display interface in response to the confirmation command to display inquiry information on the second level window for inquiring the user as to whether deletion is confirmed. At this time, the operation focus is on the second level window, and the user inputs a confirmation command again The second response module deletes the play history corresponding to the control focus in response to the confirmation command or if no user input command is received within a preset time period.

As can be seen from the above descriptions, the embodiments of the present disclosure may have the following technical effects: The stored play histories are displayed in a form of a timeline so as to be presented vertically on a screen of a TV from top to bottom for a user. When processing the play histories, the TV receives an operation command for the play histories sent from a user, detects a position where an operation focus currently is, and processes the play histories according to the operation command and the position where the operation focus currently is. Correspondingly, the user only needs to input an operation command to operate the play histories. Thus, operating the play histories on the TV by the user becomes simple, and thereby user experience is improved.

Further, a control focus is set at background, and the object on which a deletion operation is performed by the TV is set as a play history corresponding to the background control focus. By automatically switching the play histories corresponding to the control focus instead of manually selecting the play histories by the user, the operation steps which need to be performed by the user to delete a plurality of play histories are reduced. Thus, the deletion of play histories in the TV by the user becomes more convenient and thereby user experience is improved.

### Seventh Embodiment

The embodiment of the present disclosure further provides a computer readable recording medium, on which programs for performing any one of the methods according to the embodiments of the present disclosure are recorded.

The computer readable recording medium includes any mechanism for storing or transmitting information in a computer readable form, for example, a computer. For example, a machine readable medium includes a Read Only Memory (ROM), a Random Access Memory (RAM), a magnetic storage medium, an optical storage medium, a flash storage medium, transmission signals in a form of electricity, light, or sound or other forms of signals (for example, a carrier wave, an infrared signal, or a digital signal, and the like).

The above descriptions have provided many exemplary embodiments of the present disclosure, and however the protection scope of the present disclosure is not limited to this, and any modifications or substitutions which can be readily conceived by one of ordinary skill in this art without departing from the technical scope as disclosed by the present disclosure shall fall within the protection scope of the appended claims. Thus, the protection scope of the present disclosure is defined by the appended claims.

1-12. (canceled)

13. A method for processing play histories in a TV, wherein the TV has a screen on which a timeline is displayed vertically, N points in time are displayed at one side of the timeline, each of the N points in time corresponds to a play history set which comprises one or more play histories, among which a play history set corresponding to an n-th point in time is displayed between the n-th point in time and an (n+1)-th point in time at the other side of the timeline, wherein 0<n<N−1, wherein the method comprises:
receiving an operation command for the play histories sent from a user;
detecting a position where an operation focus currently is; and
processing the play histories according to the operation command and the position where the operation focus currently is.

14. The method for processing play histories in a TV according to claim 13, wherein the processing the play histories according to the operation command and the position where the operation focus currently is, comprises:
if the operation focus is on a first play history, controlling a preset trash icon to be displayed in the same row as the first play history separately from a side of the timeline, wherein the first play history is any one of the play histories displayed on the screen of the TV; and
after displaying the trash icon, if a first command for moving the operation focus and a confirmation command sent from the user are received, deleting the first play history, wherein the first command for moving the operation focus is configured to move the operation focus from the first play history onto the trash icon.

15. The method for processing play histories in a TV according to claim 14, wherein there are at least the first play history and a second play history displayed on a display interface of the TV, the first play history is displayed at a first position on the display interface, the second play history is displayed at a second position on the display interface which is next to and in the same column as the first position, and the method further comprises:
after the first play history is deleted, switching a background control focus of the TV from the first play history to the second play history, wherein when the first play history is deleted, the control focus corresponds to the first play history;
controlling the second play history to move from the second position to the first position for display; and
in response to the confirmation command from the user, deleting the second play history corresponding to the control focus.

16. The method for processing play histories in a TV according to claim 15, further comprising:
if the operation focus is on the first position, switching the background control focus of the TV to the first play history;
wherein the deleting the first play history comprises: deleting the first play history corresponding to the control focus in response to the confirmation command.

17. The method for processing play histories in a TV according to claim 16, wherein the deleting the first play history corresponding to the control focus in response to the confirmation command, comprises:
in response to the confirmation command, creating a second level window on the display interface, and displaying inquiry information on the second level window for inquiring the user as to whether deletion is confirmed; and
after displaying the inquire information, in response to the confirmation command or if no user input command is received within a preset time period, deleting the first play history corresponding to the control focus.

18. The method for processing play histories in a TV according to claim 13, wherein a history-emptying icon is further displayed on the screen of the TV, and the processing the play histories according to the operation command and the position where the operation focus currently is, comprises:
if the operation focus is on the history-emptying icon, and a confirmation command sent from the user is received, deleting all the play histories on the screen of the TV.

19. The method for processing play histories in a TV according to claim 13, wherein the processing the play histories according to the operation command and the position where the operation focus currently is, comprises:
if the operation focus is on a second play history, and a confirmation command sent from the user is received, obtaining a time when watching of a multimedia file corresponding to the second play history is last ended, wherein the second play history is any one of the play histories displayed on the screen of the TV;
enabling a play time of the multimedia file corresponding to the second play history to jump to the time when the watching of the multimedia file is last ended; and
playing the multimedia file corresponding to the second play history from the time when the watching of the multimedia file is last ended.

20. The method for processing play histories in a TV according to claim 13, wherein each of the play histories comprises a thumbnail and a name of a multimedia file, thumbnails of respective multimedia files in respective play histories are displayed at one column, and names of multimedia files in respective play histories are displayed at one column, and the thumbnail and the name of a multimedia file of one play history are displayed in the same row.

21. The method for processing play histories in a TV according to claim 20, wherein each of the play histories further comprises a storage position, and storage positions of respective play histories are correspondingly displayed on respective thumbnails of multimedia files of respective play histories; and
wherein types of the storage positions comprise local storage, external storage and non-existing, wherein when a multimedia file corresponding to a third play history is deleted from a local storage device or an external storage device, the storage position of the third play history is displayed as non-existing, wherein the third play history is any one of the play histories displayed on the screen of the TV.

22. A device for processing play histories in a TV, wherein the TV has a screen on which a timeline is displayed vertically, N points in time are displayed at one side of the timeline, each of the N points in time corresponds to a play history set which comprises one or more play histories, among which a play history set corresponding to an n-th point in time is displayed between the n-th th point in time and an (n+1)-th point in time at the other side of the timeline, wherein 0<n<N−1: wherein the device comprises:
one or more processors; and
a memory;
wherein one or more programs are stored in the memory, and when executed by the one or more processors, the one or more programs cause the one or more processors to:
receive an operation command for the play histories sent from a user;
detect a position where an operation focus currently is; and
process the play histories according to the operation command and the position where the operation focus currently is.

23. The device according to claim 22, wherein the one or more processors are configured to:
if the operation focus is on a first play history, control a preset trash icon to be displayed in the same row as the first play history separately from a side of the timeline, wherein the first play history is any one of the play histories displayed on the screen of the TV; and
after display the trash icon, if a first command for moving the operation focus and a confirmation command sent from the user are received, delete the first play history, wherein the first command for moving the operation focus is configured to move the operation focus from the first play history onto the trash icon.

24. The device according to claim 23, wherein there are at least the first play history and a second play history displayed on a display interface of the TV, the first play history is displayed at a first position on the display interface, the second play history is displayed at a second position on the display interface which is next to and in the same column as the first position; and
the one or more processors are configured to:
after the first play history is deleted, switch a background control focus of the TV from the first play history to the second play history, wherein when the first play history is deleted, the control focus corresponds to the first play history;
control the second play history to move from the second position to the first position for display; and
in response to the confirmation command from the user, delete the second play history corresponding to the control focus.

25. The device according to claim 24, wherein the one or more processors are further configured to, if the operation focus is on the first position, switch the background control focus of the TV to the first play history;
wherein the deleting of the first play history includes: deleting the first play history corresponding to the control focus in response to the confirmation command.

26. The device according to claim 25, wherein the one or more processors are configured to:
in response to the confirmation command, create a second level window on the display interface, and display inquiry information on the second level window for inquiring the user as to whether deletion is confirmed; and
after display the inquire information, in response to the confirmation command or if no user input command is received within a preset time period, delete the first play history corresponding to the control focus.

27. The device according to claim 22, wherein a history-emptying icon is further displayed on the screen of the TV, and the one or more processors are configured to:
if the operation focus is on the history-emptying icon, and a confirmation command sent from the user is received, delete all the play histories on the screen of the TV.

28. The device according to claim 22, wherein the one or more processors are configured to:
if the operation focus is on a second play history, and a confirmation command sent from the user is received, obtain a time when watching of a multimedia file corresponding to the second play history is last ended, wherein the second play history is any one of the play histories displayed on the screen of the TV;
enable a play time of the multimedia file corresponding to the second play history to jump to the time when the watching of the multimedia file is last ended; and
play the multimedia file corresponding to the second play history from the time when the watching of the multimedia file is last ended.

29. The device according to claim 22, wherein each of the play histories comprises a thumbnail and a name of a multimedia file, thumbnails of respective multimedia files in respective play histories are displayed at one column, and names of multimedia files in respective play histories are displayed at one column, and the thumbnail and the name of a multimedia file of one play history are displayed in the same row.

30. The device according to claim 29, wherein each of the play histories further comprises a storage position, and storage positions of respective play histories are correspondingly displayed on respective thumbnails of multimedia files of respective play histories; and
wherein types of the storage positions comprise local storage, external storage and non-existing, wherein when a multimedia file corresponding to a third play history is deleted from a local storage device or an external storage device, the storage position of the third play history is displayed as non-existing, wherein the third play history is any one of the play histories displayed on the screen of the TV.

31. A TV comprising a device for processing play histories in the TV, wherein the TV has a screen on which a timeline is displayed vertically, N points in time are displayed at one side of the timeline, each of the N points in time corresponds to a play history set which comprises one or more play histories, among which a play history set corresponding to an n-th point in time is displayed between the n-th point in time and an (n+1)-th point in time at the other side of the timeline, 0<n<N−1: wherein the device comprises:
one or more processors; and
a memory;
wherein one or more programs are stored in the memory, and when executed by the one or more processors, the one or more programs cause the one or more processors to:
receive an operation command for the play histories sent from a user;
detect a position where an operation focus currently is; and
process the play histories according to the operation command and the position where the operation focus currently is.

32. A computer readable recording medium, on which programs for performing a method for processing play histories in a TV are recorded, wherein the TV has a screen on which a timeline is displayed vertically, N points in time are displayed at one side of the timeline, each of the N points in time corresponds to a play history set which comprises one or more play histories, among which a play history set corresponding to an n-th point in time is displayed between the n-th point in time and an (n+1)-th point in time at the other side of the timeline, 0<n<N−1, wherein the method comprises:
receiving an operation command for the play histories sent from a user;
detecting a position where an operation focus currently is; and
processing the play histories according to the operation command and the position where the operation focus currently is.
